(19) United States
(12) Patent Application Publication
(10) Pub. No.: US 2014/0076703 A1
(43) Pub. Date: Mar. 20, 2014

(54) LIGHT EMITTING KEYBOARD

(71) Applicant: DUCKYCHANNEL INTERNATIONAL CO., LTD., Taipei City (TW)

(72) Inventor: Shih-Chuan Chao, Taipei City (TW)

(73) Assignee: Duckychannel International Co., Ltd., Taipei City (TW)

(21) Appl. No.: 13/845,957

(22) Filed: Mar. 18, 2013

(30) Foreign Application Priority Data
Sep. 19, 2012 (TW) 101218072

(51) Int. Cl. H01H 13/83

(52) U.S. Cl. CPC H01H 13/83
USPC 200/5 A

(57) ABSTRACT

A light emitting keyboard is provided. The keyboard includes: a plurality of keys, wherein each of the keys has a light source; and a controller, for turning on the light source of at least one second key when a user presses a first key.

### CROSS REFERENCE TO RELATED APPLICATIONS

This Non-provisional application claims priority under 35 U.S.C. §119(a) on Patent Application No(s). 101,218,072, filed in Taiwan, Republic of China on Sep. 19, 2012, the entire contents of which are hereby incorporated by reference.

### BACKGROUND OF THE INVENTION

1. Field of the Invention

The present invention is relates to an improvement for keyboards.

2. Description of the Related Art

A keyboard, which is composed of a plurality of keys and used as an input device, has plain appearance and simple function. When a user uses the keyboard, he can only precisely determine whether a key is being pressed according to the mechanical sound of the key. This is boring and not entertaining. Therefore, the present invention provides a new keyboard which has better aesthetics and sense of operation, thus having added value characteristics.

### BRIEF SUMMARY OF THE INVENTION

The present invention provides a light emitting keyboard. The keyboard comprises: a plurality of keys, wherein each of the keys has a light source; and a controller, for turning on the light source of at least one second key when a user presses a first key.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1A and 1B are schematic diagrams of a light emitting keyboard according to an embodiment of the present invention.

FIG. 2 shows the light emitting keyboard 100 of the present invention under a single key emitting mode.

FIG. 3 is the light emitting keyboard 100 of the present invention under the surrounding keys emitting mode.

FIG. 4 is the light emitting keyboard 100 of the present invention under the ripple style emitting mode.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

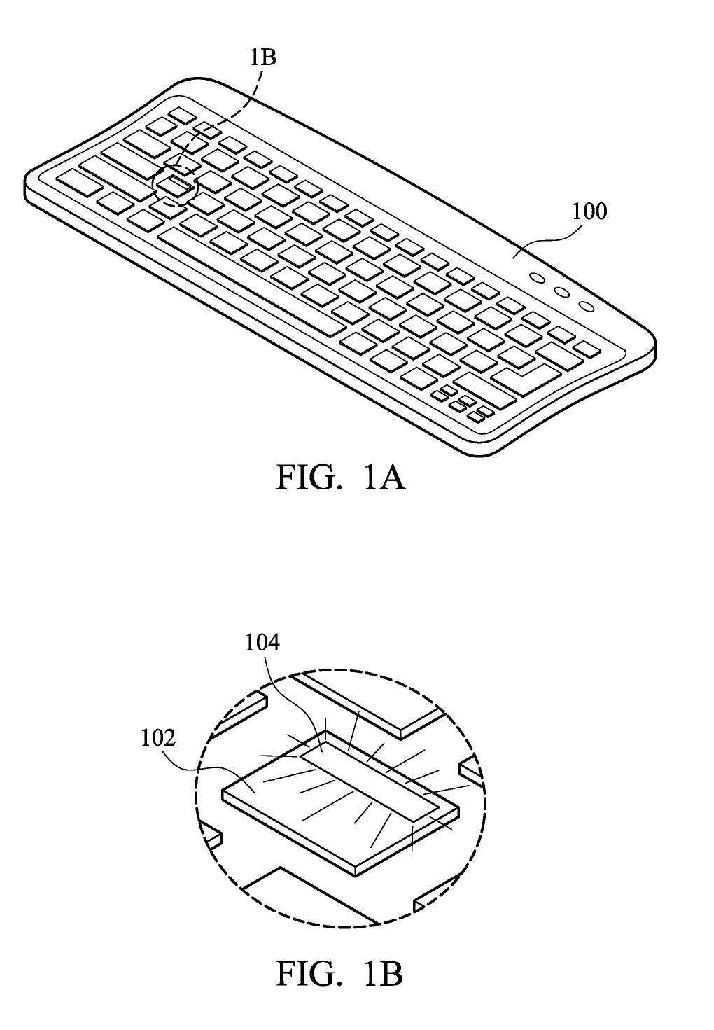

The present invention improves keyboards by adding better aesthetics and sense of operation. FIGS. 1A and 1B are schematic diagrams of a light emitting keyboard according an embodiment of the present invention. The light emitting keyboard 100 of the present invention has a plurality of keys 102, and each key 102 has a light source 104 which can be turned on and off. As shown in FIGS. 1A and 1B, in this embodiment, the light source of the key 104 is an inner LED built into the casing of the key 102. When the inner LED is turned on, the light is emitted through any light transmitting region on the proper position of the key 102. In other embodiments, the position, size and the shape of the light transmitting region are not limited to the embodiments in FIG. 1A and FIG. 1B, and those skilled in the art can appropriately design and modify the configuration of the light sources. Since the light emitting keyboard of the present invention is luminous, it is particularly suitable for dim environments.

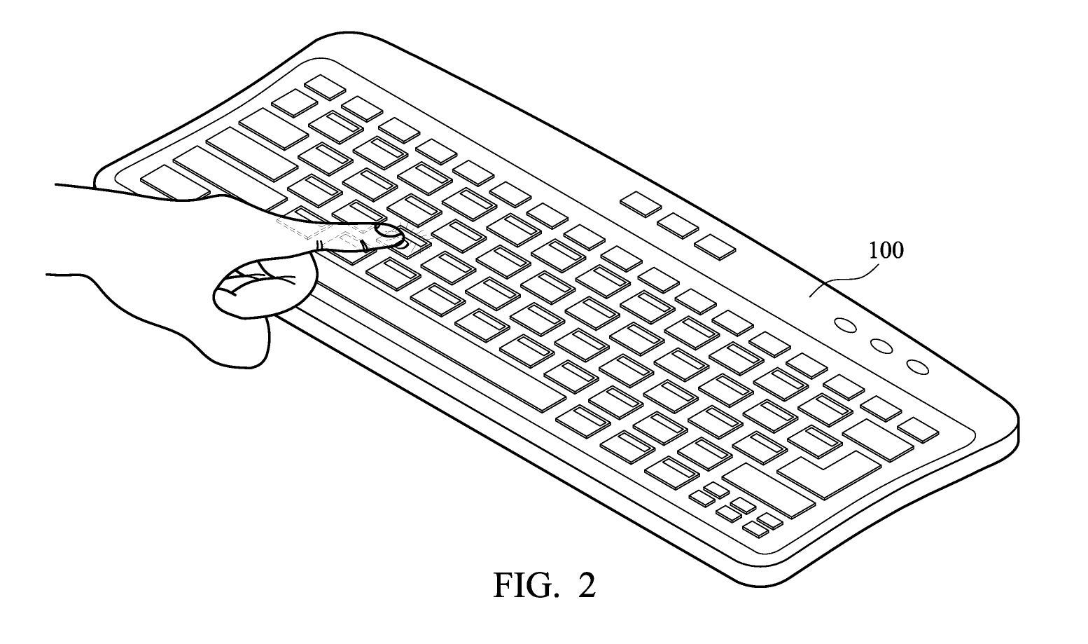

Note that the light emitting keyboard 100 of the present has a unique controller embedded in the keyboard 100 (not shown in Figs.). When a user presses a first key of the keys, the controller can turn on the light source of one or more than one second key, and when the user stop pressing the first key, the controller can turns off the second key (hereinafter, the “first key” represents the key which is pressed, and the “second key” represents the key having a light source thereof turned on). The second key having a light source thereof turned on is not necessary to be the first key which is being pressed. Which keys are turned on depends on the modes of the controller. Various modes of the light emitting keyboards of the present invention will be further described in the following embodiments in accordance with FIGS. 2-4.

### Single Key Emitting Mode

FIG. 2 shows the light emitting keyboard 100 of the present invention under a single key emitting mode. As shown in FIG. 2, under this mode, the first key is the second key (i.e., the pressed key is the key having the light source thereof turned on). For example, the key D pressed by the user is turned on and emits light, but the other keys that are not pressed by the user are not turned on. In this manner, the keys on the keyboard can flicker according to the pressing of the user's finger. Thus, a new operating experience is created, which also helps to enhance the sense of operation. Note that in some embodiments, when the user releases the first key, the turning off of the light source of the second key is delayed and the user can control and set the length of the delay time. In addition, in some embodiments, the luminance of the light source can also be designed to gradually weaken before being turned off.

### Surrounding Keys Emitting Mode

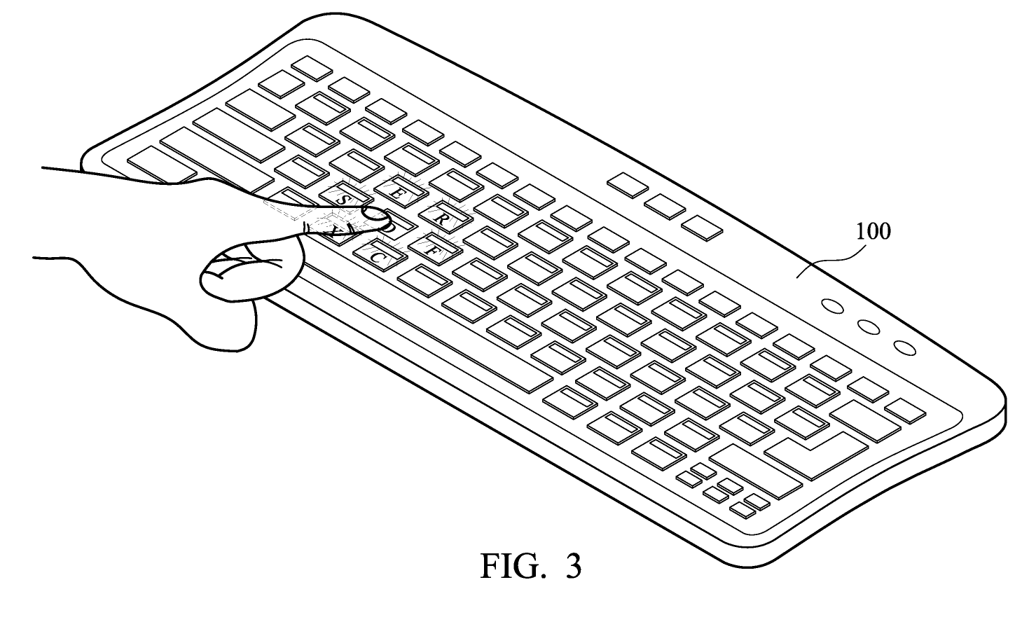

FIG. 3 is the light emitting keyboard 100 of the present invention under the surrounding keys emitting mode. As shown in FIG. 3, under this mode, the second keys (the keys with light sources turned on) are those keys surrounding the first key (the pressed key). For example, when the user presses the key D (the first key), the light source of the key D is not turned on, but the light sources of the keys E, R, S, F, X, and C that surround the key D are turned on. Thus, a new operating experience which is different from that of the single key emitting mode described above is created. This embodiment is merely for illustration, and in other embodiments, the surrounding keys of the key D may include keys other than the key E, R, S, F, X, and C. In some embodiments, the surrounding keys can be turned on at different times with various styles, which will be further described in the following embodiments.

### Breathing Light Mode

The breathing light mode (not shown in Figs.) can be performed with the single key emitting mode or the surrounding keys emitting mode together. In this mode, the second keys (whose light source is turned on) can vary the brightness of the light sources with a specific frequency. In other words, the brightness of the second keys gradually repeatedly increases and then gradually weakens. When the specific frequency is mimics the human respiratory rate, the stable lighting variation will give users a breathing-like feel, thus adding a new entertaining operating experience to users.

### Ripple Style Emitting Mode

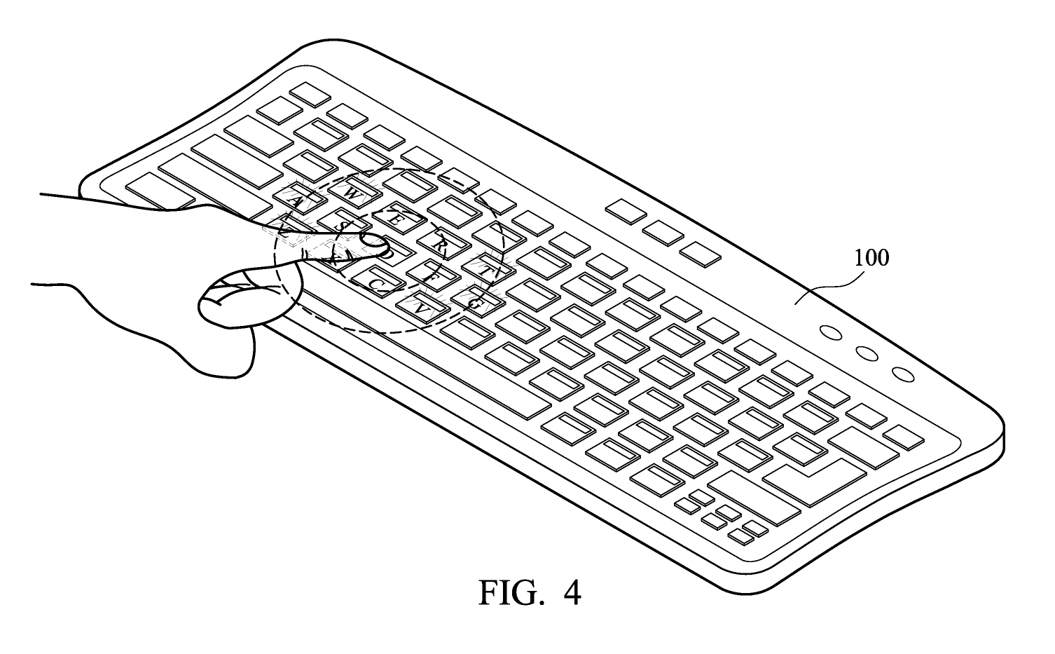

FIG. 4 is the light emitting keyboard 100 of the present invention under the ripple style emitting mode. The ripple style emitting mode is a variant of the surrounding keys emitting mode. In this mode, the second keys having light sources which are turned on include various layers of key groups. For example, when the first key is key D, the first layer key group of the second keys can include the keys which are surrounding and closely adjacent to the first key D, such as the keys E, R, S, F, X, and C, and, the second layer key group can include the keys which are surrounding and closely adjacent to the first layer key group, such as the keys T, G, V, Q, A, and Z, and so on. However, different from the surrounding keys emitting mode, each of the key grounds in the ripple style emitting mode are turned on and off at different time. In a better embodiments, the second layer key group is turned on/off at a time slightly later than that of the time of that of the first layer key group, the third layer key group is turned on/off at a time slightly later than that of the time that the second layer key group is turned on/off, and so on (As shown in FIG. 4, when the light sources of the first layer key group are turned off, the light sources of the second layer key group are turned on). This emitting mode can create an effect similar to water wave ripples, thus improving the aesthetics of the light emitting keyboard.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light emitting keyboard, comprising:
a plurality of keys, wherein each of the keys has a light source; and
a controller, for turning on the light source of at least one second key when a user presses a first key.

2. The light emitting keyboard as claimed in claim 1, wherein the controller turns off the light source of the at least one second key in real time or in a delayed time when the user stops pressing the first key.

3. The light emitting keyboard as claimed in claim 1, wherein the at least one second key comprises the first key.

4. The light emitting keyboard as claimed in claim 1, wherein the at least one second key comprises the keys surrounding the first key,

5. The light emitting keyboard as claimed in claim 4, wherein the at least one second key comprises a first layer key group having keys surrounding and closely adjacent to the first key.

6. The light emitting keyboard as claimed in claim 5, wherein the at least one second key further comprises a second layer key group having keys surrounding and closely adjacent to the first layer key group.

7. The light emitting keyboard as claimed in claim 6, wherein the first and the second layer key groups are turned on and/or off at different time.

8. The light emitting keyboard as claimed in claim 7, wherein the second layer key group is turned on and/or off after the first layer key group is turned on and/or off.

9. The light emitting keyboard as claimed in claim 1, wherein the light source of the at least one second key changes brightness with a frequency when turned on.

10. The light emitting keyboard as claimed in claim 1, wherein the keyboard is a mechanical keyboard.
